(19) United States
(12) Patent Application Publication
(10) Pub. No.: US 2026/0136108 A1
(43) Pub. Date: May 14, 2026

(54) METHOD AND AN APPARATUS FOR IMAGE PROCESSING

(71) Applicant: Black Sesame Technologies Co., Ltd., Wuhan (CN)

(72) Inventors: Donghui Wu, San Mateo, CA (US); Mengchuan Dong, Shanghai (CN); Chao Wang, Shanghai (CN)

(21) Appl. No.: 19/388,872

(22) Filed: Nov. 13, 2025

(30) Foreign Application Priority Data
Nov. 13, 2024 (CN) 2024116214771

(51) Int. Cl. H04N 23/76; H04N 23/72; H04N 23/73; H04N 23/88

(52) U.S. Cl. CPC H04N 23/76; H04N 23/72; H04N 23/73; H04N 23/88

(57) ABSTRACT

A method and an apparatus for image processing adapted for converting an image captured by a vehicle-mounted camera into a target image. The image processing method includes: determining a grid division pattern and a corresponding weight assignment manner according to an installation posture and an acquisition perspective of the vehicle-mounted camera; dividing the image into an above-ground grid and a preset number of ground grids by using the grid division pattern, the preset number being related to the grid division pattern; and assigning a corresponding weight to each grid by using the weight assignment manner and determining a target feature parameter of the target image based on a feature parameter corresponding to each pixel in the grid.

### RELATED APPLICATION

This application claims the benefit under 35 U.S.C. § 119(a) of the filing date of Chinese Patent Application No. 2024116214771, filed in the Chinese Patent Office on Nov. 13, 2024. The disclosure of the foregoing application is herein incorporated by reference in its entirety.

### TECHNICAL FIELD

The present disclosure relates to the field of autonomous driving, and in particular to a method and device for processing an image captured by a vehicle-mounted camera.

### BACKGROUND

In recent years, autonomous driving technology has developed rapidly, and visual perception technology has played a vital role in intelligent driving, such as automatic parking, surround view stitching, and planning control. Depending on requirements of application scenarios, vehicles are equipped with different numbers of cameras at specific installation locations.

For example, a vehicle-mounted panoramic reversing imaging system requires at least one camera to be installed in each of the four directions of the vehicle: front, rear, left, and right. These cameras are used to capture images around the vehicle, and when displayed, images around the vehicle are present from a top-down perspective, i.e., a bird's-eye view image. Obviously, these vehicle-mounted cameras do not directly capture top-down images. Instead, the front images, rear images, left-side images and rear-side images captured by multiple cameras are converted into bird's-eye views and stitched together to generate a panoramic image. It can be imagined that when actual images captured by the vehicle-mounted cameras are converted to other perspectives for display, region of interest (ROI) in the images will be significantly different due to different perspectives. For example, a nearby region that occupies a large proportion in a front view actually occupies a small proportion in the bird's-eye view, and a distant road region that occupies a small proportion in the front view actually occupies a large proportion in the bird's-eye view. Therefore, when converting perspectives for display, arranging the statistical window (a rectangle or a combination of multiple rectangles) based on the original capturing perspective often results in abnormal proportions in the bird's-eye view. At the same time, under complex lighting conditions—such as when there are vehicle lights nearby and street lights in the distance—if conventional methods are used for automatic exposure statistics or white balance statistics, the color and exposure in the bird's-eye view will tend to favor the nearby regions that occupies a larger proportion in the front view, while neglecting the distant region that occupies a large proportion in the bird's-eye view.

Even in a case of image display where there is no need for perspective conversion, such as a single-lens reversing image display, it is also necessary for the vehicle-mounted cameras to flexibly adjust the white balance settings to obtain accurate color and exposure when encountering backlight conditions or multi-light-source environments under night vision scenarios. These situations are also closely related to the division pattern for splitting the image into statistical windows.

The traditional statistical window is shown in FIG. 1 or FIG. 2. FIG. 1 shows a division pattern of uniformly planned rectangular statistical windows, and FIG. 2 shows a division pattern of rectangular statistical windows planned with different resolutions. The window division pattern shown in FIG. 2 can also be equivalently obtained by configuring different weights for the window in FIG. 1. Obviously, as mentioned above, the traditional statistical window division pattern is not conducive to the image display after perspective conversion, nor it is conducive to automatic exposure statistics or white balance statistics.

To solve the above problems, the present disclosure proposes an image processing method and device.

### SUMMARY

The present disclosure proposes an image processing method and device, which can correspondingly set the division pattern and weight assignment manner for statistical windows based on the application scenario of the vehicle-mounted camera, so that the weight of each window is determined by its importance in the final application scenario.

According to one aspect of the present disclosure, the present disclosure provides an image processing method adapted for converting an image captured by a vehicle-mounted camera into a target image. According to one aspect, the image processing method includes: determining a grid division pattern and its corresponding weight assignment manner according to an installation posture and an acquisition perspective of the vehicle-mounted camera; dividing the image into one above-ground grid and a preset number of ground grids by using the grid division pattern, the preset number being related to the grid division pattern; and assigning a corresponding weight to each grid by using the weight assignment manner, and determining a target feature parameter of each grid to be presented in the target image by the grid based on a feature parameter of the grid, the target feature parameters of all grids constituting a target feature parameter of the target image.

According to one aspect, the grid division pattern includes M first dividing lines L₁ᵢ extending along a first direction and arranged sequentially along a second direction, and N−1 second dividing lines L₂ⱼ extending in directions intersecting with the first direction, the N−1 second dividing lines L2j do not intersect with each other and have different extending directions, and are arranged sequentially along the first direction, where i∈[1,M], j∈[1,N−1], M≥2, N≥2, the first direction and the second direction are perpendicular, and dividing the image into one above-ground grid and the preset number of ground grids by using the grid division pattern, including: dividing the image into an above-ground grid and a first ground grid by using a first dividing line L11; and dividing the first ground grid into M*N ground grids by using a first dividing line L1k and N−1 second dividing lines L2j, where k∈[2,M] and M*N is the preset number.

According to one aspect, the weight assignment manner is a manual assignment manner, a weight of each ground grid is a positive value, and among the M*N ground grids, weights of M ground grids arranged sequentially along the second direction in any column decrease successively, and weights of the N ground grids arranged sequentially along the first direction in any row decrease successively from a middle grid to grids on both sides, and a weight of the above-ground grid is the smallest.

According to one aspect, an extension direction of at least one of the second dividing lines is parallel to an extension direction of a lane line in the image.

According to one aspect, before determining the grid division pattern and its corresponding weight assignment manner according to the installation posture and acquisition perspective of the vehicle-mounted camera, the method further includes: preprocessing the image to obtain a region of interest (ROI) in the image, the preprocessing at least including removing an invalid region in the image; and dividing the image into one above-ground grid and the preset number of ground grids by using the grid division pattern includes: taking the ROI as a division object of the grid division pattern, and dividing the ROI by using the grid division pattern to divide the ROI into one above-ground grid and the preset number of ground grids.

According to one aspect, the invalid region is represented by an upper boundary, a lower boundary, a left boundary, and a right boundary, and removing the invalid region in the image includes: acquiring the upper boundary, the lower boundary, the left boundary, and the right boundary of the image based on the installation posture of the vehicle-mounted camera; and removing regions of the upper boundary, the lower boundary, the left boundary, and the right boundary from the image to form the ROI.

According to one aspect, the target image is a bird's-eye view image, the target feature parameter is a certain statistic of a content of the image, such as brightness statistics and color statistics. Before determining the grid division pattern and its corresponding weight assignment manner according to the installation posture and acquisition perspective of the vehicle-mounted camera, the method further includes: acquiring an intrinsic parameter corresponding to the image and a corresponding extrinsic parameter that is capable of being mapped to a bird's-eye view; dividing the image sample by using a grid division pattern corresponding to the installation posture and acquisition perspective of the vehicle-mounted camera to obtain the preset number of ground grids; for each ground grid, determining a mapping relationship between an image coordinate system of the image and a target coordinate system of the target image based on the intrinsic parameter and extrinsic parameter; calculating a mapped grid of the ground grid in the bird's-eye view image by using the mapping relationship; and determining a weight of the ground grid by using a relationship between areas of the mapped grid and the ground grid; and weights of all ground grids and the weight of the above-ground grid constitute the weight assignment manner.

According to one aspect, calculating the mapped grid of the ground grid in the bird's-eye view image by using the mapping relationship includes: dividing the ground grid into a plurality of quadrilateral pixel regions; for each pixel region in the ground grid, calculating the coordinates of four mapped points in the target coordinate system corresponding to coordinates of four vertices of the pixel region using the mapping relationship between the image coordinate system and the target coordinate system, a quadrilateral enclosed by the four mapped points constitutes a mapped region corresponding to the pixel region; determining the weight of the ground grid by using the relationship between the areas of the mapped grid and the ground grid includes: for each pixel region, calculating an area of the pixel region and an area of its corresponding mapped region; taking a ratio of the area of the mapped region corresponding to each pixel region to the area of the pixel region as a weight of the pixel region; and taking an average value of the weights of all pixel regions of the ground grid as the weight of the ground grid.

According to one aspect, quadrilateral pixel region is a unit square region centered at any pixel point.

According to one aspect, the image processing method further includes: setting the weight of the above-ground grid manually, the weight of the above-ground grid is smaller than the weight of any one of the ground grids.

According to one aspect, the feature parameter is a white balance statistic, and assigning the corresponding weight to each grid by using the weight assignment manner and determining the target feature parameter of each grid to be presented in the target image by the grid based on the feature parameter of the grid includes: calculating a target reference white balance statistic of the target image based on the reference white balance statistics of all grids and their corresponding weights; and adjusting white balance statistics of all grids based on the target reference white balance statistic to calculate a white balance gain for generating the target image.

According to one aspect, the feature parameter is a brightness statistic, and assigning the corresponding weight to each grid by using the weight assignment manner and determining the target feature parameter of each grid to be presented in the target image by the grid based on the feature parameter of the grid includes: calculating the target reference exposure statistics of the target image based on the reference exposure statistics of all grids and their corresponding weights; and adjusting exposure statistics of all grids based on the target reference exposure statistics to calculate an automatic exposure control amount and an automatic gain control amount to generate the target image.

According to another aspect of the present disclosure, an image processing device is also disclosed, including: at least one memory for storing a computer program; and at least one processor connected to the at least one memory, the at least one processor being configured to execute the computer program, the computer program, when executed, implements the aforementioned image processing method.

According to another aspect of the present disclosure, a computer storage medium is also disclosed for storing a computer program, the computer program, when executed, implements the aforementioned image processing method.

### BRIEF DESCRIPTION OF THE DRAWINGS

In order to illustrate the embodiments of the present application or the technical solutions in traditional techniques more clearly, the following briefly introduces the drawings required for use in the embodiments or the description of traditional techniques. Obviously, the drawings described below are only some embodiments of the present application. For a person skilled in the art, other drawings can be obtained according to these accompanying drawings without inventive effort.

FIG. 1 is a schematic diagram illustrating a uniform rectangular grid division pattern according to traditional techniques;

FIG. 2 is a schematic diagram illustrating a non-uniform rectangular grid division pattern according to traditional techniques;

FIG. 3 is a schematic flow chart illustrating an image processing method in an embodiment according to one aspect of the present disclosure;

FIG. 4 is a schematic diagram illustrating an acquisition perspective of a rearview camera in an embodiment according to one aspect of the present disclosure;

FIG. 5 is a schematic diagram illustrating a grid division pattern in an embodiment according to one aspect of the present disclosure;

FIG. 6 is a schematic diagram illustrating a grid division pattern in an embodiment according to one aspect of the present disclosure;

FIG. 7 is a schematic diagram illustrating a grid division pattern in an embodiment according to one aspect of the present disclosure;

FIG. 8 is a schematic flow diagram illustrating grid division steps in an embodiment according to one aspect of the present disclosure;

FIG. 9 is a schematic flow diagram illustrating preprocessing steps in an embodiment according to one aspect of the present disclosure;

FIG. 10 is a schematic diagram illustrating a mapping relationship in an embodiment according to one aspect of the present disclosure;

FIG. 11 is a schematic flow diagram illustrating a method for determining a weight assignment manner in an embodiment according to one aspect of the present disclosure; and

FIG. 12 is a schematic block diagram illustrating an image processing device in an embodiment according to another aspect of the present disclosure.

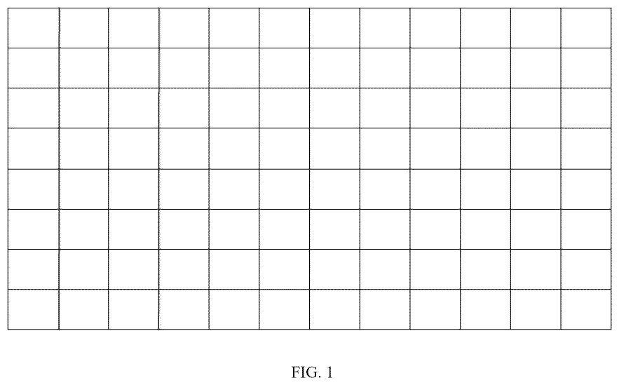

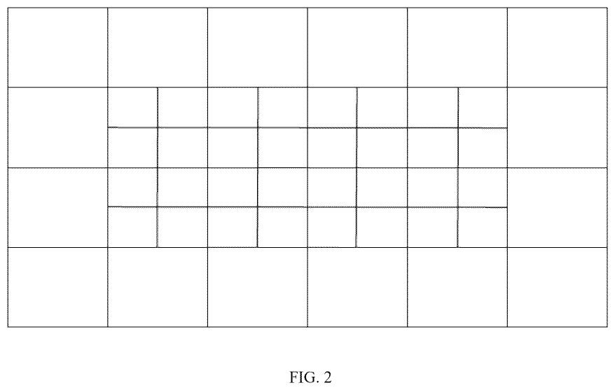

### DETAILED DESCRIPTION

The technical solutions in the embodiments of the present application will be clearly described below in conjunction with the drawings in the embodiments of the present disclosure. Obviously, the described embodiments are only part of the embodiments of the present disclosure, rather than all the embodiments. Based on the embodiments in the present disclosure, all other embodiments obtained by a person skilled in the art without inventive effort shall fall within the scope of the present disclosure.

According to one aspect of the present disclosure, an image processing method is provided, adapted for converting an image captured by a vehicle-mounted camera into a target image.

The vehicle-mounted camera refers to the manufacturer-configured or aftermarket-installed photo-taking device or video-taking device installed on the vehicle for capturing images outside the vehicle.

The target image refers to the application scenario of the vehicle-mounted camera, specifically to the final presented image of the image captured by the vehicle-mounted camera. For example, the bird's-eye view image presented in the panoramic reversing image and the captured image are directly displayed in the reversing image of a single camera. It can be concretely understood as the picture or video that is ultimately displayed to the people in the vehicle through the vehicle-mounted display device.

Different application scenarios of vehicle-mounted cameras result in different key image parameters of the target image. For example, in a bird's-eye view image, key image parameters are the size or proportion of lanes and any pedestrians/objects on the lanes that may affect vehicle driving, and in a rearview image, the key image parameters are the color and exposure, etc. Therefore, vehicle-mounted cameras in different application scenarios may have different target images, and the key image parameters of the target images may also be different, such as exposure statistics in automatic exposure control (AEC) and white balance statistics in automatic white balance (AWB) control.

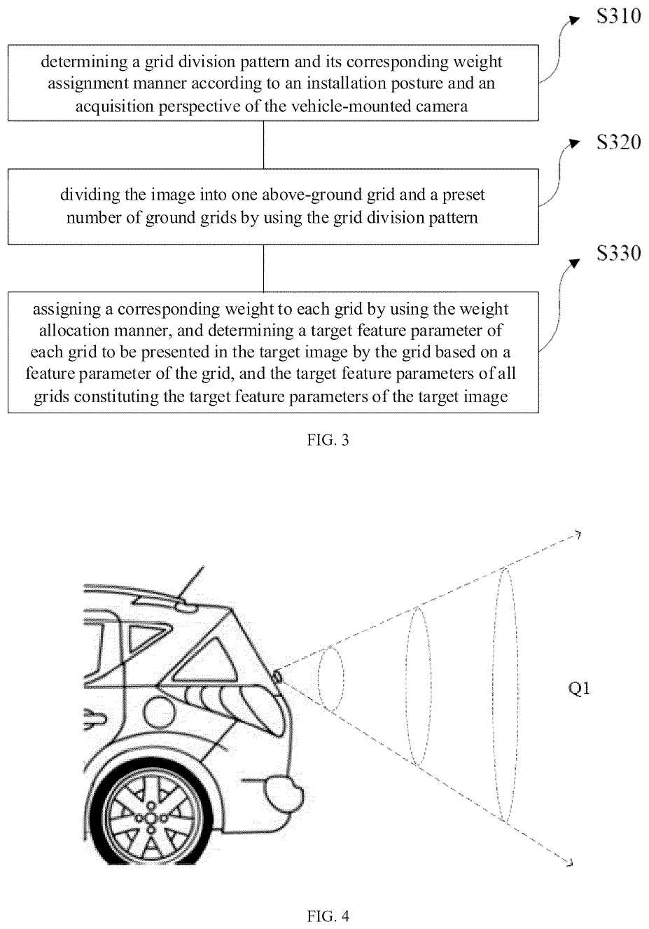

Specifically, FIG. 3 shows a schematic diagram of steps of an image processing method according to an embodiment. As shown in FIG. 3, the image processing method may include steps S310 to S330.

Step S310 is: determining a grid division pattern and its corresponding weight assignment manner according to an installation posture and an acquisition perspective of the vehicle-mounted camera.

The installation posture of a vehicle-mounted camera refers to the installation position of the vehicle-mounted camera on the vehicle, the roll angle, pitch angle and heading angle of the vehicle-mounted camera, and other parameters that affect the capturing region and capturing angle of the vehicle-mounted camera.

The acquisition perspective refers to the field of view of the vehicle-mounted camera, which is usually a spatial angle measured from its installation position as the origin, such as the acquisition perspective Q1 of the rear-view vehicle-mounted camera in a specific embodiment shown in FIG. 4. The acquisition perspective is related to the focal length of the vehicle-mounted camera. Differences in the acquisition perspective may affect the range of the effective region in the image captured by the vehicle-mounted camera. Taking the side-view cameras as an example, a partial vehicle body often appears in its captured images. However, drivers only need to know the vehicle boundary, and do not need to see the vehicle body. Therefore, the partial vehicle body captured by the cameras should be minimized—but not entirely absent. The area of the vehicle body that appears in the image captured by the vehicle-mounted camera jointly determined by the acquisition perspective and installation posture. In a preferred grid division pattern, the vehicle body is typically designated as an invalid region. This is because, in some application scenarios like the commonly used bird's-eye view image, the vehicle body is often represented by a fixed virtual image rather than the actual captured image.

The grid division pattern refers to dividing the image into statistical windows. The weight assignment manner refers to assigning a weight to each statistical window.

It can be understood that the installation posture and acquisition perspective of the vehicle-mounted camera determine the effective range of the image captured by the vehicle-mounted camera and the image presentation status within this range. Therefore, regardless of whether the vehicle-mounted camera is installed correctly or whether changes occur during actual operation, the effective range of the currently captured image and the image presentation status within this range can be determined based on the current installation posture and acquisition perspective of the vehicle-mounted camera, and then the grid division pattern can be determined accordingly through a preset method.

Optionally, in other embodiments, a preprocessing step may be included before step S310. Through the preprocessing, the images captured by the vehicle-mounted camera under different postures or perspectives are processed into preprocessed images that meet the implementation requirements of the grid division pattern.

Step S320 is: dividing the image into one above-ground grid and a preset number of ground grids by using the grid division pattern.

During the implementation of the present disclosure, the present disclosure has identified that one of the problem with traditional statistical window division pattern lies in the uniform division of all regions in the image and/or the assignment of identical weights to all windows. The present disclosure at least distinguishes the grid division patterns and weight values of the above-ground part and the ground part in the image.

The above-ground grid refers to the sky region in the image or the region that is above the ground and higher than the horizon in the image. It can be understood that the horizon refers to the actual driving surface of the vehicle. Depending on the terrain, the horizon in the image may appear as a relatively flat line or an irregular one. Those skilled in the art can set a straight line close to the ground plane based on the acquisition perspective of the vehicle-mounted camera as the dividing line between the above-ground grid and the ground grid, which is called a ground plane dividing line. Generally, the ground plane dividing line is parallel to the lower edge of the image. Preferably, the ground plane dividing line can be set as any straight line, parallel to the lower edge, that passes through any point within the interval from the horizon's highest point to its lowest point, or even can be set within an interval extending from slightly above the horizon's highest point to slightly below its lowest point. It can be understood that most of the region above the ground plane is the sky, and the relatively close region below the ground plane is generally farther away from the vehicle, so the ground plane dividing line does not need to be very accurate.

Then, the region above the ground plane dividing line constitutes one above-ground grid, while the region below it can be further divided by additional dividing lines to form multiple ground grids. The number of ground grids is directly related to the grid division pattern, so the preset number corresponds to the grid division pattern in one-to-one correspondence.

The multiple dividing lines included in the grid division pattern can be stored in the form of coordinates. Taking the image coordinate system of the image as the coordinate system for the grid division pattern as an example, the multiple division lines for grid division are stored in the form of the coordinates of each pixel point on them or the coordinates of the pixel points at both ends of them. Then, during division, the grid division can be completed by connecting the pixel points corresponding to the stored coordinates on the image. The focus of the present disclosure is on the shape of the grid division, and does not limit the implementation method of the division operation. Those skilled in the art can understand that all methods that can achieve the grid division results described in this disclosure should be included in the scope of the present disclosure.

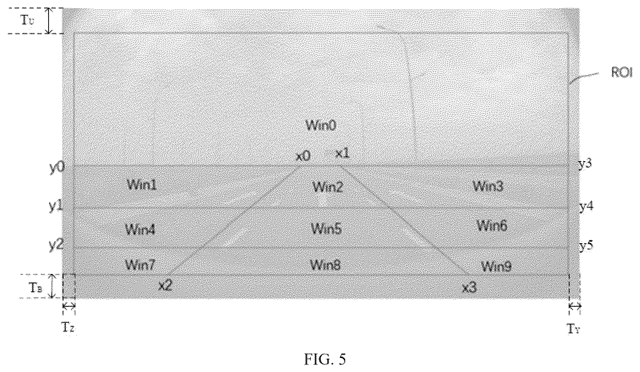

FIG. 5 shows a schematic diagram of a grid division shape in an embodiment. As shown in FIG. 5, y0-y3 is the ground plane dividing line that divides the image into the above-ground grid Win0 and the ground part. The ground part is further divided into 3*3 grids Win1, Win2, Win3, Win4, Win5, Win6, Win7, Win8 and Win9 by dividing lines y1-y4, y2-y5, x0-x2 and x1-x3. Among them, the dividing lines y1-y4 and y2-y5 are parallel to the lower edge of the image, and the dividing line x0-x2 and dividing line x1-x3 have an angle with the extension direction of the lower edge that is not equal to 90°. Preferably, the dividing line x0-x2 and the dividing line x1-x3 extend along the lane line in the image.

It can be understood that FIG. 5 divides the rear view perspective into left, middle and right in the horizontal direction, and into near, medium-distance and far in the vertical direction. The grids Win1, Win2, Win3, Win4, Win5, Win6, Win7, Win8 and Win9 represent far left, far middle, far right, medium-distance left, medium-distance middle, medium-distance right, near left, near middle and near right respectively.

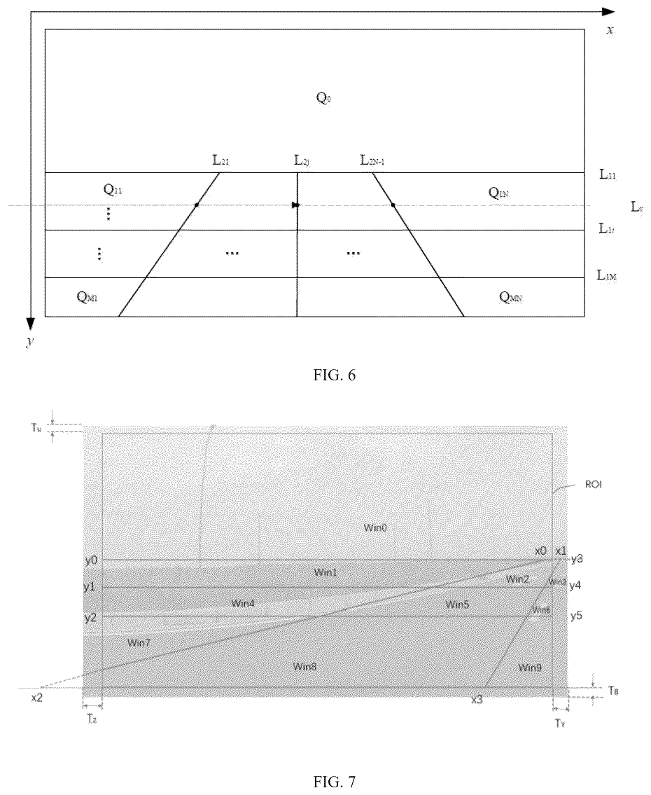

In combination with the embodiment shown in FIG. 5, FIG. 6 shows a schematic diagram of grid division. As shown in FIG. 6, the grid division pattern includes M first dividing lines L₁ᵢ and N−1 second dividing lines L₂ⱼ, i∈[1,M], j∈[1,N−1], M≥2, N≥2. M first dividing lines L₁ᵢ extend along the first direction x and are arranged sequentially along a second direction y; N−1 second dividing lines L₂ⱼ do not intersect with each other and have different extending directions. At the same time, the extension direction of any one of the second dividing lines L₂ⱼ intersects with the first direction x, and the first direction x and the second direction y are perpendicular.

It should be noted that “do not intersect with each other” means: there is no intersection between multiple line segments; “different extension directions” means: with any direction as a reference axis, the rotation angles of the extension lines of multiple line segments relative to the reference axis are not equal; “arranged sequentially” means: with a straight line passing through all dividing lines as the reference axis, the intersection points of all dividing lines with the reference axis are arranged sequentially in accordance with the extension direction of the dividing lines; for example, “N−1 second dividing lines are arranged sequentially along the first direction x” means: with reference to FIG. 6, with a straight line Lx with an extension direction parallel to the first direction x and passing through all second dividing lines as the reference axis, then the intersection points of the second dividing lines L₂₁-L_{2N-1} with the reference axis Lx are arranged sequentially.

Preferably, the extension direction of at least one second dividing line L₂ⱼ is parallel to the extension direction of any lane line in the image; when the lane lines in the image are symmetrical on the left and right, N−1 second dividing lines are symmetrically distributed on the left and right. If N−1 is an odd number, the N/2th second dividing line can extend along the axis of symmetry. Based on the characteristics of the second dividing line, in some embodiments, the second dividing line may also be drawn based on image recognition.

It can be understood that when the second dividing line extends along the lane line, the grid division pattern is closest to driving requirements. In this disclosure, “the extension direction is parallel to the extension direction of the lane line” means: the rotation angle of the extension direction relative to the extension direction of the lane line falling within an acceptable error range. That is, during grid division, it is sufficient that the second dividing line is roughly parallel to the lane line.

Preferably, in the grid division pattern for the front-view or rear-view camera, M can be set to 3 and N can be set to 3.

Preferably, the basic settings of the grid division patterns for multiple vehicle-mounted cameras can be the same, such as 3*3. However, in the grid division pattern for the side-view camera, the 3*3 grid setting is made equivalent to 2*2 through special parameter configuration.

FIG. 7 shows a schematic diagram of a grid division shape of a side-view camera in an embodiment. The reference numerals in FIG. 7 have the same meaning as the corresponding reference numerals in FIG. 5, and can be understood by reference. As shown in FIG. 7, a schematic diagram of a side-front view is provided herein, where x1 and x2 are set outside the image range, and some grids such as win3 almost do not exist. It can be understood that in other embodiments, dividing lines y2-y5 and x0-x2 may be set outside the image range, and the ground portion may be divided into 2*2 ground grids by dividing lines y1-y4 and x1-x3.

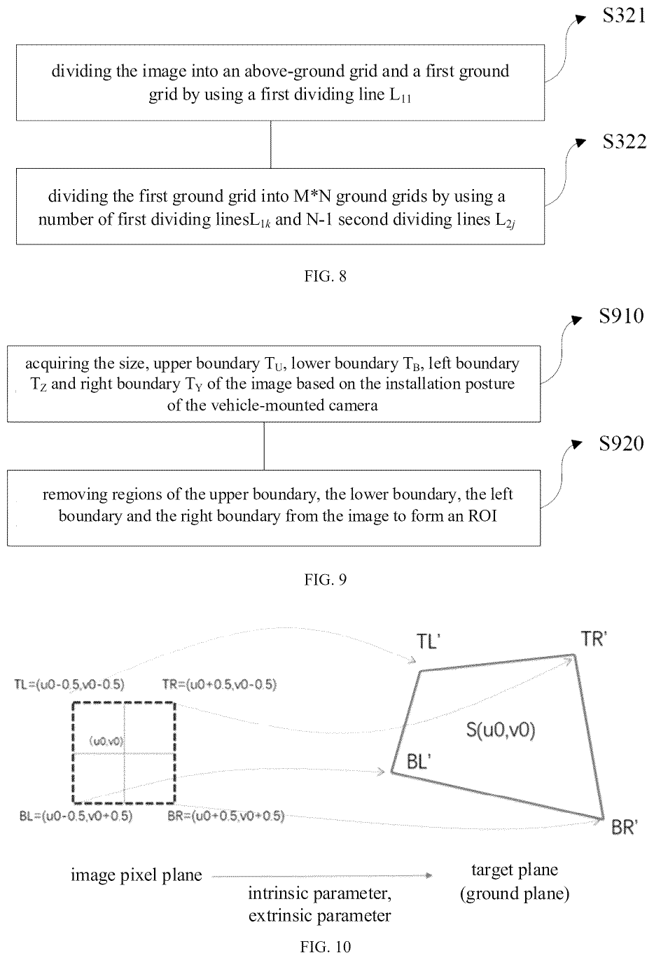

FIG. 8 shows a schematic flow diagram of grid division steps based on the grid division pattern shown in FIG. 6. As shown in FIG. 8, step S320 may include steps S321 to S322.

Step S321 is: dividing the image into an above-ground grid and a first ground grid by using a first dividing line L₁₁.

The above-ground grid refers to the region above the ground plane dividing line. The first ground grid refers to the grid other than the above-ground grid divided by the ground plane dividing line. It should be noted that, in the present disclosure, the first dividing line L₁₁ refers to the dividing line closest to the sky portion in the image, that is, the ground plane dividing line.

Step S322 is: dividing the first ground grid into M*N ground grids by using a number of first dividing lines L₁ₖ and N−1 second dividing lines L₂ⱼ, where k∈[2,M].

The aforementioned preset number of ground grids is M*N ground grids.

Further, the embodiment shown in FIG. 5 obviously sets a region of interest (ROI). As shown in FIG. 5, in some embodiments, a preprocessing step may be further provided before step S310: preprocessing the image captured by the vehicle-mounted camera to obtain an ROI of the image. The preprocessing includes at least removing invalid boundaries in the image. These invalid boundaries are typically regions of the vehicle body or regions where the field of view is occluded by the lens frame.

FIG. 9 shows a schematic diagram of a sub-flow of the preprocessing step in an embodiment. As shown in FIG. 9, the preprocessing step includes steps S910 to S920.

Step S910 is: acquiring the size, upper boundary T_{U}, lower boundary T_{B}, left boundary T_{Z} and right boundary T_{Y} of the image based on the installation posture of the vehicle-mounted camera.

Step S920 is: removing regions of the upper boundary, the lower boundary, the left boundary and the right boundary from the image to form an ROI.

It should be noted that the edges in the present disclosure refer to four sides of a rectangular image, and the boundary refers to a long strip-shape region with a certain width extending from one edge of the image to its opposite edge.

Further, the preprocessing step may also include other conventional preprocessing steps in the art, such as perspective correction of the vehicle-mounted camera, etc.

It can be understood that in the embodiment covering the preprocessing step, the objects of application of the image processing methods S310 to S330 should all be replaced by the ROI.

Further, as shown in FIG. 3, after the grid division is completed, step S330 is: assigning a corresponding weight to each grid by using the weight assignment manner, and determining a target feature parameter of each grid to be presented in the target image by the grid based on a feature parameter of the grid, the target feature parameters of all grids constituting a target feature parameter of the target image.

The weight assignment manner can be a manual assignment manner by those skilled in the art based on experience; it can also be to inversely assign weights to the grids in the corresponding image based on the characteristics of the target image; or it can also be determined by using known corresponding images and target images as samples, and employing mathematical computation or machine learning methods to determine the weight assignment manner for samples with known grid division patterns.

The manual assignment manner is described below with reference to the grid division pattern shown in FIG. 6. As shown in FIG. 6, M*N ground grids are represented in the form of a matrix. Then the j-th column of grids arranged along the y direction is Q₁ⱼ˜Q_{Mj}, and the i-th row of grids arranged along the x direction is Qᵢ₁˜Q_{iN}, where i∈[1,M], j∈[1,N−1], and Q₁ⱼ is the grid closest to the ground plane dividing line. Then, in the j-th column of grids Q₁ⱼ˜Q_{Mj}, the weights of grids Q₁ⱼ˜Q_{Mj} typically decrease sequentially, that is, the weights of the M ground grids arranged along the second direction decrease sequentially; in the i-th row of grids Qᵢ₁˜Q_{iN}, the weights of grids Qᵢ₁˜Q_{iN} typically decrease from the middle to both sides, that is, the weights of the N ground grids arranged along the first direction decrease from the middle grid to the grids on both sides; the weight of the above-ground grid Q₀ is the smallest.

Taking the grid division pattern shown in FIG. 5 as an example, the weight of window Win0 can be set to 1, the weight of window Win1 can be set to 20, the weight of window Win2 can be set to 16, the weight of window Win3 can be set to 20, the weight of window Win4 can be set to 12, the weight of window Win5 can be set to 8, the weight of window Win6 can be set to 12, the weight of window Win7 can be set to 9, the weight of window Win8 can be set to 6, and the weight of window Win9 can be set to 9.

It could be understood that based on the application scenarios of vehicle-mounted cameras, the cost increase brought about by high computing power, and the visual requirements of the naked eye, reasonable M and N values can be set and should not be expanded indefinitely. For vehicle-mounted front-view, rear-view, and side-view cameras, the typical configuration is M=N=3, usually M≤5, N≤5.

The following provides an illustrative example of how to determine the weight assignment manner through calculation, based on specific application scenarios.

Taking a bird's-eye view image as an example of the target image, the conversion relationships between the image coordinate system, the vehicle coordinate system, and the world coordinate system are common knowledge in the field and will not be described in detail below. Those skilled in the art can obtain theoretical and detailed explanations by searching the Internet or referring to textbooks.

Those skilled in the art will understand that after the vehicle-mounted camera is installed on the vehicle, its position and posture relative to the vehicle coordinate system (or world coordinate system) are determined. In fact, for cameras pre-installed by automobile manufacturers, the position and posture of the camera relative to the vehicle or the world coordinate system are relatively determined after the vehicle model is designed, and its design parameters basically meet the application requirements of the present disclosure.

Assuming camera intrinsic parameter

$$K = [ \begin{matrix}{f}_{x} & & {c}_{x} \\ & {f}_{y} & {c}_{y} \\ & & 1\end{matrix} ] ,$$

it is assumed that the camera distortion has been removed. Points on the road surface P_{w}=[xₓ, yₓ, z_{w}=0]^{t}. Assume that the rotation matrix and translation vector of the camera extrinsic parameter are

$${R}_{w \to c} = [ \begin{matrix}{r}_{11} & {r}_{12} & {r}_{13} \\ {r}_{21} & {r}_{22} & {r}_{23} \\ {r}_{31} & {r}_{32} & {r}_{33}\end{matrix} ] and \\ {T}_{w \to c} = {[ {t}_{x} , {t}_{y} , {t}_{z} ]}^{t}$$

respectively. The pixel position of the point on the road surface imaged in the camera is

$${p}_{u} = [ \begin{matrix}{u}_{u} \\ {v}_{u} \\ 1\end{matrix} ] = \frac{1}{{z}_{c}} [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {r}_{13} & {t}_{x} \\ {r}_{21} & {r}_{22} & {r}_{23} & {t}_{y} \\ {r}_{31} & {r}_{32} & {r}_{33} & {t}_{z}\end{matrix} ] \vert \begin{matrix}{x}_{w} \\ {y}_{w} \\ {z}_{w} \\ 1\end{matrix} \vert = \frac{1}{{z}_{c}} {KHP}_{w} , where [ \begin{matrix}{x}_{c} \\ {y}_{c} \\ {z}_{c} \\ 1\end{matrix} ] = [ \begin{matrix}{R}_{w \to c 3 x 3} & {T}_{w \to c 3 x 1} \\ {0}^{T} & 1\end{matrix} ] [ \begin{matrix}{x}_{w} \\ {y}_{w} \\ {z}_{w} \\ 1\end{matrix} ] .$$

Where fₓ and f_{y} are the focal lengths in pixels for the camera's horizontal and vertical directions, respectively, cₓ and c_{y} are the coordinates of the principal point of the camera, respectively, x_{w}, y_{w} and z_{w} are the coordinates of point P_{w} in the world coordinate system, r₁₁, r₁₂, r₁₃, r₂₁, r₂₂, r₂₃, r₃₁, r₃₂ and r₃₃ are nine elements of the rotation matrix (3×3) of the camera extrinsic parameter, tₓ, t_{y} and t_{z} are the three components of the camera extrinsic parameter translation vector, respectively, pᵤ is the pixel of the point P_{w} on the road imaged in the camera, and

$$[ \begin{matrix}{u}_{u} \\ {v}_{u} \\ 1\end{matrix} ]$$

is the coordinate of the pixel in the image coordinate system (1 indicates that the image coordinate system is a two-dimensional coordinate system).

When z_{w}=0 (only considering points on the ground (in the world coordinate system z=0)), it is simplified to:

$${p}_{u} = [ \begin{matrix}{u}_{u} \\ {v}_{u} \\ 1\end{matrix} ] = \frac{1}{{z}_{c}} [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {t}_{x} \\ {r}_{21} & {r}_{22} & {t}_{y} \\ {r}_{31} & {r}_{32} & {t}_{z}\end{matrix} ] \vert \begin{matrix}{x}_{w} \\ {y}_{w} \\ 1\end{matrix} \vert = \frac{1}{{z}_{c}} {KH}^{′} {P}_{w}^{′} \qquad ( 1 )$$

If the distortion effect of the lens is further considered, the coordinates of the actual ground point

$${P}_{w}^{′}$$

projected to the pixel in the camera are:

$$p = LensDistort ( {p}_{u} ) \qquad ( 2 )$$

LensDistort(⋅) is the mapping relationship of lens distortion.

From the above geometric relationship, the mapping from actual ground points to image pixel coordinates can be obtained.

In the embodiment taking the bird's-eye view image as the target image, a plane to be finally used is selected according to the aforementioned geometric relationship and is defined as the z=0 lane of the world coordinate stem.

$${p}_{u} = [ \begin{matrix}{u}_{u} \\ {v}_{u} \\ 1\end{matrix} ] = \frac{1}{{z}_{c}} [ \begin{matrix}{f}_{x} & 0 & {c}_{x} \\ 0 & {f}_{y} & {c}_{y} \\ 0 & 0 & 1\end{matrix} ] [ \begin{matrix}{r}_{11} & {r}_{12} & {t}_{x} \\ {r}_{21} & {r}_{22} & {t}_{y} \\ {r}_{31} & {r}_{32} & {t}_{z}\end{matrix} ] \vert \begin{matrix}{x}_{w} \\ {y}_{w} \\ 1\end{matrix} \vert = \frac{1}{{z}_{c}} {KH}^{′} {P}_{w}^{′} , \\ p = LensDistort ( {p}_{u} ) .$$

Considering that this mapping is plane to plane, it can also be expressed in reverse:

$${p}_{u} = UnDistort ( p ) {P}_{w}^{′} = [ \begin{matrix}{x}_{w} \\ {y}_{w} \\ 1\end{matrix} ] = {{\frac{1}{{z}_{w}} [ \begin{matrix}{r}_{11} & {r}_{12} & {t}_{x} \\ {r}_{21} & {r}_{22} & {t}_{y} \\ {r}_{31} & {r}_{32} & {t}_{z}\end{matrix} ]}^{- 1} [ \begin{matrix}{f}_{x} & 0 & {c}_{x} \\ 0 & {f}_{y} & {c}_{y} \\ 0 & 0 & 1\end{matrix} ]}^{- 1} [ \begin{matrix}{u}_{u} \\ {v}_{u} \\ 1\end{matrix} ] = \frac{1}{{z}_{w}} {H}^{′ - 1} {K}^{- 1} {p}_{u} \qquad ( 3 )$$

For a small surface element du dv in the image, which corresponds to dx dy on the ground plane, the area magnification factor of this surface element during the projection process from the image to the ground plane corresponds to its importance.

$$r ( p ) = {\vert \frac{dx dy}{du dv} \vert}_{{u}_{0} {v}_{0}} \qquad ( 4 )$$

However, there may not be an analytical expression for describing lens distortion, so it may be difficult to directly use function differentiation to solve r(p). In practice, it can be solved through numerical methods. As shown in FIG. 10, for a unit square TL-TR-BR-BL centered at the pixel point (u0, v0) in the image pixel plane, its four vertices can be projected to their corresponding points TL′, TR′, BL′, and BR′ in the target plane (ground plane) through the above transformation. The ratio of the area of the quadrilateral formed by these four points to the area of the unit square in the pixel plane can be regarded as the weight of the center point (u0, v0) of the unit square in the pixel plane. It should be pointed out that this ratio is ultimately reflected as the weight of the statistical pixel, and the weight itself is also of relative significance, so the area unit can be ignored for the area within the target plane. Regarding the area of a quadrilateral TL′-TR′-BR′-BL′, given that the coordinates of the four vertices are known, there are many ways for calculation, including but not limited to, calculating the length of each side and one of the diagonals using the coordinates of the four points, then calculating the area of the two triangles divided by the diagonal using Heron's formula, and subsequently summing up to obtain the area of the quadrilateral.

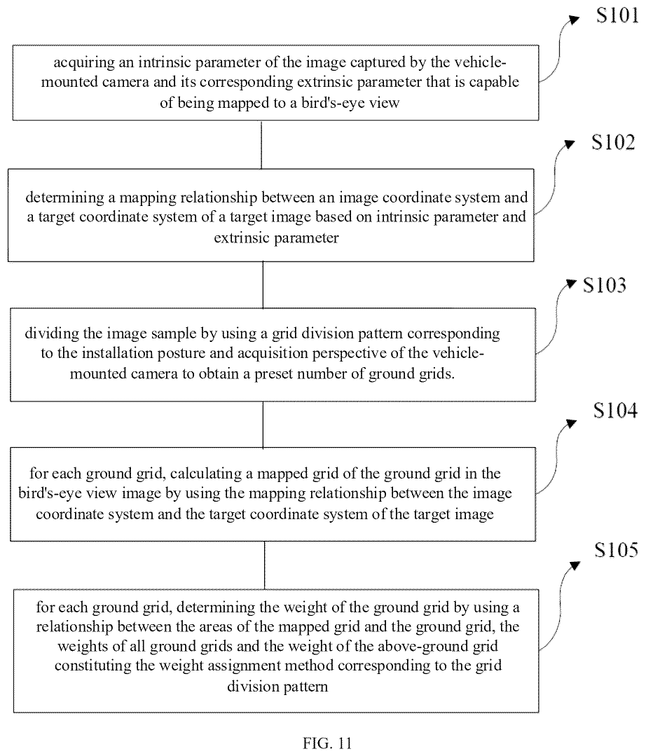

In conjunction with the aforementioned calculation process, FIG. 11 shows a schematic flow diagram of a process for determining the weight assignment manner for a grid division pattern in an embodiment. As shown in FIG. 11, the steps of determining the weight assignment manner of the grid division pattern may include steps S101 to S105.

Step S101 is: acquiring an intrinsic parameter of the image captured by the vehicle-mounted camera and a corresponding extrinsic parameter that is capable of being mapped to a bird's-eye view.

Step S102 is: determining a mapping relationship between an image coordinate system of the image captured by the vehicle-mounted camera and a target coordinate system of a target image based on the intrinsic parameter and extrinsic parameter.

Step S103 is: dividing the image sample by using a grid division pattern corresponding to the installation posture and the acquisition perspective of the vehicle-mounted camera to obtain a preset number of ground grids.

Different installation postures and acquisition perspectives may correspond to different grid division patterns. Therefore, it is necessary to determine the weight assignment manner for the image samples of each grid division pattern.

Step S104 is: for each ground grid, calculating a mapped grid of the ground grid in the bird's-eye view image by using the mapping relationship between the image coordinate system and the target coordinate system of the target image.

In the bird's-eye view image, the target coordinate system is the earth's coordinate system.

Specifically, step S104 can be refined as follows: dividing the ground grid into a number of quadrilateral pixel regions. For each pixel region in the ground grid, the coordinates of four mapped points in the target coordinate system corresponding to the coordinates of the four vertices of the pixel region is calculated using the mapping relationship between the image coordinate system and the target coordinate system. The quadrilateral enclosed by the four mapping points constitutes a mapped region corresponding to the pixel region.

It can be understood that in order to save computing power, each grid can be divided into a certain number of pixel regions. When the computing power is sufficient, each pixel point can be set as one pixel region.

Step S105 is: for each ground grid, determining the weight of the ground grid by using a relationship between the areas of the mapped grid and the ground grid. The weights of all ground grids and the weight of the above-ground grid constitute the weight assignment manner corresponding to the grid division pattern.

Corresponding to the refined step of step 104, step S105 can be refined as follows: for each pixel region, calculating the area of the pixel region and the area of its corresponding mapped region; taking the ratio of the area of the mapped region corresponding to each pixel region to the area of the pixel region as the weight of the pixel region; and taking the average value of the weights of all pixel regions in the ground grid as the weight of the ground grid.

It could be understood that the step of determining the weight assignment manner of a grid division pattern further includes setting the weight of the above-ground grid. The simplest way is manual setting. Usually, the weight of the above-ground grid is set to the minimum value, that is, less than the weight of any ground grid.

The above descriptions, by taking the bird's-eye view image as the target image as an example, have provided a detailed explanation of the method for determining the weight assignment manner in this application scenario. In specific application scenarios, such as AEC and AWB, the weight assignment manner and grid division pattern may be different, but they can basically be obtained accordingly based on the comparison between the parameter feature of the target image and the corresponding parameter feature in the acquired image in the sample.

Taking the white balance application scenario as an example, the corresponding feature parameter is the white balance statistic, and the aforementioned step S130 can be correspondingly refined as follows: calculating a target reference white balance statistic of the target image based on the reference white balance statistics of all grids and their corresponding weights; and adjusting the white balance gains of all grids based on the target reference white balance statistic to generate the target image.

Taking the exposure control application scenario as an example, the corresponding feature parameter is the exposure statistic, and the aforementioned step S130 can be correspondingly refined as follows: calculating a target reference exposure statistic of the target image based on the reference exposure statistics of all grids and their corresponding weights; and adjusting the exposure statistics of all grids based on the target reference exposure statistic to calculate an automatic exposure and automatic gain control values, thereby generating the target image.

It could be understood that in complex lighting condition, such as parking lot environments, the rearview camera often exhibit a scene that the near field is reddish (caused by brake lights) and the far field is bluish-green (caused by ambient lighting). If conventional statistical methods are used, the near field occupies a large area, and the red light from the brake lights in the near field dominates the statistics. Obviously, using the nearby ground as the white balance reference will result in an abnormal displayed image. Further, after being projected to the ground perspective, the residual green light in the far field will occupy a large area, and the color in the bird's-eye view is very abnormal. After adopting the grid division pattern of the present disclosure, the weight of the far-field region is increased, and the AWB result will tend to use the far field ground as the white balance reference, which will be relatively normal after being projected to a bird's-eye view.

The descriptions of the processes corresponding to the aforementioned figures each have their own emphasis. For parts not detailed in a particular process, one can refer to the relevant descriptions in other processes.

According to another aspect of the present disclosure, an image processing device is provided.

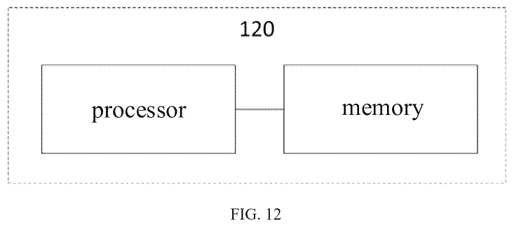

FIG. 12 shows a schematic block diagram of an image processing device 120 in one embodiment. As shown in FIG. 12, the image processing device 120 includes at least one memory 121 (one is taken as an example in FIG. 12) and at least one processor 122 (one is taken as an example in FIG. 12), at least one memory 121 being configured to store computer programs, and at least one processor 122 being configured to run the program stored in the at least one memory 121 to implement the image processing method described above.

It should be understood that the processor in the embodiments of the present disclosure may be a central processing unit (CPU), and the processor may also be other general-purpose processors, digital signal processors (DSP), application specific integrated circuits (ASIC), field programmable gate arrays (FPGA) or other programmable logic devices, discrete gate or transistor logic devices, discrete hardware components, etc. A general purpose processor may be a microprocessor, or the processor may be any conventional processor or the like.

It should also be understood that the memory in the embodiments of the present disclosure may be a volatile memory or a non-volatile memory, or may include both volatile and non-volatile memories. The non-volatile memory may be a read-only memory (ROM), a programmable read-only memory (PROM), an erasable programmable read-only memory (EPROM), an electrically erasable programmable read-only memory (EEPROM), or a flash memory. Volatile memory can be random access memory (RAM), which acts as external cache memory. By way of example but not limitation, many forms of random access memory (RAM) are available, such as static RAM (SRAM), dynamic random access memory (DRAM), synchronous DRAM (SDRAM), double data rate SDRAM (DDR SDRAM), enhanced SDRAM (ESDRAM), synchronous link DRAM (SLDRAM), and direct rambus RAM (DR RAM).

According to yet another aspect of the present disclosure, a non-transitory computer-readable storage medium is provided, which is configured to store a computer program. When the computer program is directly or indirectly executed, the image processing method described above can be implemented.

The above embodiments may be implemented in whole or in part through software, hardware, firmware or any other combination. When implemented using software, the above embodiments may be implemented in whole or in part in the form of a computer program product. The computer program product includes one or more computer instructions or computer programs. When the computer instructions or computer program are loaded or executed on a computer, the process or function described in the embodiments of the present disclosure is generated in whole or in part. The computer may be a general-purpose computer, a special-purpose computer, a computer network, or other programmable device. The computer instructions can be stored in a computer-readable storage medium, or transmitted from one computer-readable storage medium to another computer-readable storage medium. For example, the computer instructions can be transmitted from one website, computer, server or data center to another website, computer, server or data center via a wired method (such as infrared, wireless, microwave, etc.). The computer-readable storage medium may be any available medium that can be accessed by a computer or a data storage device such as a server or a data center that includes a collection of one or more available media. The available medium may be a magnetic medium (e.g., a floppy disk, a hard disk, a magnetic tape), an optical medium (e.g., a DVD), or a semiconductor medium. The semiconductor medium may be a solid state drive.

It should be understood that the term “and/or” in this article is merely a description of the association relationship between associated objects, indicating that three relationships may exist. For example, A and/or B can mean: A exists alone, A and B exist at the same time, and B exists alone, A and B can be singular or plural. In addition, the character “/” in this application generally indicates that the associated objects before and after it are in an “or” relationship, but it may also indicate an “and/or” relationship. Please refer to the previous and next context for specific understanding.

In this application, “at least one” means one or more, and “more than one” means two or more. “At least one of the following items” or similar expressions refers to any combination of these items, including any combination of single items or plural items. For example, at least one of a, b, or c can represent: a, b, c, a-b, a-c, b-c, or a-b-c, where a, b, and c can be single or multiple.

It should be understood that in the various embodiments of the present disclosure, the size of the serial numbers of the above-mentioned processes does not mean the order of execution. The execution order of each process should be determined by its function and internal logic, and should not constitute any limitation on the implementation process of the embodiments of the present disclosure.

Those skilled in the art will appreciate that the units and algorithm steps of each example described in conjunction with the embodiments disclosed herein can be implemented by electronic hardware, or a combination of computer software and electronic hardware. Whether these functions are performed in hardware or software depends on the specific application and design constraints of the technical solution. Professional technicians can use different methods to implement the described functions for each specific application, but such implementation should not be considered to be beyond the scope of this disclosure.

In the several embodiments provided in this disclosure, it should be understood that the disclosed devices and methods can be implemented in other ways. For example, the device embodiments described above are merely illustrative and may be divided into different functional units from a functional perspective.

If the functions are implemented in the form of software functional units and sold or used as independent products, they can be stored in a computer-readable storage medium. Based on this understanding, at least a portion of the technical solution of the present disclosure, can be embodied in the form of a software product. The computer software product is stored in a storage medium and includes a number of instructions for enabling a computer device (which can be a personal computer, a server, or a network device, etc.) to execute all or part of the steps of the method described in each embodiment of the present disclosure. The aforementioned storage media include: USB flash drives, mobile hard drives, read-only memory (ROM), random access memory (RAM), magnetic disks or optical disks, and other media that can store program codes.

The above is only a specific implementation method of the present disclosure, but the scope of the present disclosure is not limited thereto. Any person skilled in the art, within the technical scope disclosed in the present disclosure, may readily contemplate variations or substitutions, which shall fall within the scope of the present disclosure. Therefore, the scope of the present disclosure shall be subject to the scope of the claims.

1. A method for converting an image captured by a vehicle-mounted camera into a target image, the method comprising:
determining a grid division pattern and a corresponding weight assignment manner according to an installation posture and an acquisition perspective of the vehicle-mounted camera;
dividing the image into an above-ground grid and a preset number of ground grids by using the grid division pattern, wherein the preset number is related to the grid division pattern; and
assigning a corresponding weight to each grid by using the weight assignment manner, and
determining a target feature parameter of each mid of the above-around grid and a preset number of ground grids to be presented in the target image based on a feature parameter of the grid, wherein target feature parameters of the above-ground grid and the preset number of ground grids constitute a target feature parameter of the target image.

2. The method according to claim 1, wherein the grid division pattern comprises M first dividing lines L₁ᵢ extending along a first direction and arranged sequentially along a second direction, and N−1 second dividing lines L₂ⱼ extending in directions intersecting with the first direction, the N−1 second dividing lines L₂ⱼ do not intersect with each other and have respective extending directions, and are arranged sequentially along the first direction, wherein i∈[1,M], j∈[1,N−1], M≥2, N≥2, the first direction and the second direction are perpendicular, and
wherein dividing the image into the above-ground grid and the preset number of ground grids by using the grid division pattern, comprises:
dividing the image into the above-ground grid and a first ground grid by using a first dividing line L₁₁; and
dividing the first ground grid into M*N ground grids by using a first dividing line L₁ₖ and N−1 second dividing lines L₂ⱼ, wherein k∈[2,M] and M*N is the preset number.

3. The method according to claim 2, wherein the weight assignment manner is a manual assignment manner, wherein a weight of each ground grid of the M*N ground grids is a positive value, wherein weights of M ground grids arranged sequentially along the second direction in any column decrease successively, and wherein weights of the N ground grids arranged sequentially along the first direction in any row decrease successively from a middle grid of the N ground rid to grids on both sides of the N ground grids, and wherein a weight of the above-ground grid is the smallest among the weight of the M*N ground grids and the weight of the above-ground grid.

4. The method according to claim 2, wherein an extension direction of at least one of the second dividing lines is parallel to an extension direction of a lane line in the image.

5. The method according to claim 1, wherein:
before determining the grid division pattern and the corresponding weight assignment manner according to the installation posture and the acquisition perspective of the vehicle-mounted camera, the method further comprises:
preprocessing the image to obtain a region of interest (ROI) in the image, the preprocessing at least comprising removing an invalid region in the image; and
wherein dividing the image into the above-ground grid and the preset number of ground grids by using the grid division pattern comprises:
taking the ROI as a division object of the grid division pattern, and dividing the ROI using the grid division pattern to divide the ROI into the above-ground grid and the preset number of ground grids.

6. The method according to claim 5, wherein the invalid region is represented by an upper boundary, a lower boundary, a left boundary, and a right boundary, and wherein removing the invalid region in the image comprises:
acquiring the upper boundary, the lower boundary, the left boundary, and the right boundary of the image based on the installation posture of the vehicle-mounted camera; and
removing regions of the upper boundary, the lower boundary, the left boundary, and the right boundary from the image to form the ROI.

7. The method according to claim 1, wherein the target image is a bird's-eye view image, the target feature parameter is a statistic of a content of the image, and before determining the grid division pattern and the corresponding weight assignment manner according to the installation posture and the acquisition perspective of the vehicle-mounted camera, the method further comprises:
acquiring an intrinsic parameter corresponding to the image and a corresponding extrinsic parameter that is capable of being mapped to a bird's-eye view;
determining a mapping relationship between an image coordinate system of the image and a target coordinate system of the target image based on the intrinsic parameter and the extrinsic parameter;
dividing the image by using the grid division pattern corresponding to the installation posture and acquisition perspective of the vehicle-mounted camera to obtain the preset number of ground grids; and
for each ground grid,
calculating a mapped grid of the ground grid in the bird's-eye view image by using the mapping relationship; and
determining a weight of the ground grid by a relationship between areas of the mapped grid and the ground grid; and
wherein weights of the preset number of ground grids and the weight of the above-ground grid constitute the weight assignment manner.

8. The method according to claim 7, wherein:
calculating the mapped grid of the ground grid in the bird's-eye view image by using the mapping relationship comprises:
dividing the ground grid into a number of quadrilateral pixel regions; and
for each quadrilateral pixel region of the number of quadrilateral pixel regions in the ground grid, calculating coordinates of four mapped points in the target coordinate system corresponding to coordinates of four vertices of the pixel region using the mapping relationship, wherein a quadrilateral enclosed by the four mapped points constitutes a mapped region corresponding to the quadrilateral pixel region;
wherein determining the weight of the ground grid by using the relationship between the areas of the mapped grid and the ground grid comprises:
for each quadrilateral pixel region of the number of quadrilateral pixel regions in the ground grid,
calculating an area of the quadrilateral pixel region and an area of a corresponding mapped region;
computing a ratio of the area of the corresponding mapped region to the area of the quadrilateral pixel region as a weight of the quadrilateral pixel region; and
computing an average value of the weights of the number of quadrilateral pixel regions of the ground grid as the weight of the ground grid.

9. The method according to claim 8, wherein the quadrilateral pixel region is a unit square region centered at any pixel point.

10. The method according to claim 7, wherein further comprising:
setting the weight of the above-ground grid manually, wherein the weight of the above-ground grid is smaller than the weight of any one of the preset number of ground grids.

11. The method of claim 1, wherein the feature parameter comprises a white balance statistic, and assigning the corresponding weight to each grid by using the weight assignment manner and determining the target feature parameter of each grid to be presented in the target image by the grid based on the feature parameter of the grid comprises:
calculating a target reference white balance statistic of the target image based on reference white balance statistics of all grids and their corresponding weights; and
adjusting white balance statistics of all grids based on the target reference white balance statistic to calculate a white balance gain of the target image for generating the target image.

12. The method of claim 1, wherein the feature parameter comprises an exposure statistic, and assigning the corresponding weight to each grid by using the weight assignment manner and determining the target feature parameter of each grid to be presented in the target image by the grid based on the feature parameter of the grid comprises:
calculating a target reference exposure statistic of the target image based on reference exposure statistics of all grids and their corresponding weights; and
adjusting exposure statistics of all grids based on the target reference exposure statistic to calculate an automatic exposure control amount and an automatic gain control amount of the target image for generating the target image.

13. A device, comprising:
at least one memory for storing a computer program; and
at least one processor connected to the at least one memory, the at least one processor being configured to execute the computer program that,
once executed, causes the device to perform operations for converting an image captured by a vehicle-mounted camera into a target image, the operations comprising:
determining a grid division pattern and a corresponding weight assignment manner according to an installation posture and an acquisition perspective of the vehicle-mounted camera;
dividing the image into an above-ground rid and a preset number of ground grids by using the grid division pattern, wherein the preset number is related to the grid division pattern; and
assigning a corresponding weight to each grid by using the weight assignment manner, and
determining a target feature parameter of each grid of the above-ground grid and a preset number of ground grids to be presented in the target image based on a feature parameter of the grid, wherein target feature parameters of the above-ground grid and the preset number of ground grids constitute a target feature parameter of the target image.

14. A non-transitory computer storage medium for storing a computer program that, once executed by a processor causes the processor to perform operations for converting an image captured by a vehicle-mounted camera into a target image, the operations comprising:
determining a grid division pattern and a corresponding weight assignment manner according to an installation posture and an acquisition perspective of the vehicle-mounted camera;
dividing the image into an above-ground rid and a preset number of ground grids by using the grid division pattern, wherein the preset number is related to the grid division pattern; and
assigning a corresponding weight to each grid by using the weight assignment manner, and determining a target feature parameter of each grid of the above-ground grid and a preset number of ground grids to be presented in the target image based on a feature parameter of the grid, wherein target feature parameters of the above-ground grid and the preset number of ground grids constitute a target feature parameter of the target image.

15. The device of claim 13, wherein the grid division pattern comprises M first dividing lines L₁ᵢ extending along a first direction and arranged sequentially along a second direction, and N−1 second dividing lines L₂ⱼ extending in directions intersecting with the first direction, the N−1 second dividing lines L₂ⱼ do not intersect with each other and have respective extending directions, and are arranged sequentially along the first direction, wherein i∈[1,M], j∈[1,N−1], M≥2, N≥2, the first direction and the second direction are perpendicular, and
wherein dividing the image into the above-ground grid and the preset number of ground grids by using the grid division pattern, comprises:
dividing the image into the above-ground grid and a first ground grid by using a first dividing line L₁₁; and
dividing the first ground grid into M*N ground grids by using a first dividing line L₁ₖ and N−1 second dividing lines L₂ⱼ, wherein k∈[2,M] and M*N is the preset number.

16. The device of claim 15, wherein the weight assignment manner is a manual assignment manner, wherein a weight of each ground grid of the M*N ground grids is a positive value, wherein weights of M ground grids arranged sequentially along the second direction in any column decrease successively, and wherein weights of the N ground grids arranged sequentially along the first direction in any row decrease successively from a middle grid of the N ground grids to grids on both sides of the N ground grids, and wherein a weight of the above-ground grid is the smallest among the weight of the M*N ground grids and the weight of the above-ground grid.

17. The device of claim 13, wherein before determining the grid division pattern and the corresponding weight assignment manner according to the installation posture and the acquisition perspective of the vehicle-mounted camera, the operations further comprise:
preprocessing the image to obtain a region of interest (ROI) in the image, the preprocessing at least comprising removing an invalid region in the image; and
wherein dividing the image into the above-ground grid and the preset number of ground grids by using the grid division pattern comprises:
taking the ROI as a division object of the grid division pattern, and dividing the ROI using the grid division pattern to divide the ROI into the above-ground grid and the preset number of ground grids.

18. The non-transitory computer storage medium of claim 14, wherein the grid division pattern comprises M first dividing lines L₁ᵢ extending along a first direction and arranged sequentially along a second direction, and N−1 second dividing lines L₂ⱼ extending in directions intersecting with the first direction, the N−1 second dividing lines L₂ⱼ do not intersect with each other and have respective extending directions, and are arranged sequentially along the first direction, wherein i∈[1,M], j∈[1,N−1], M≥2, N≥2, the first direction and the second direction are perpendicular, and
wherein dividing the image into the above-ground grid and the preset number of ground grids by using the grid division pattern, comprises:
dividing the image into the above-ground grid and a first ground grid by using a first dividing line L₁₁; and
dividing the first ground grid into M*N ground grids by using a first dividing line L₁ₖ and N−1 second dividing lines L₂ⱼ, wherein k∈[2,M] and M*N is the preset number.

19. The non-transitory computer storage medium of claim 18, wherein the weight assignment manner is a manual assignment manner, wherein a weight of each ground grid of the M*N ground grids is a positive value, wherein weights of M ground grids arranged sequentially along the second direction in any column decrease successively, and wherein weights of the N ground grids arranged sequentially along the first direction in any row decrease successively from a middle grid of the N ground grids to grids on both sides of the N ground grids, and wherein a weight of the above-ground grid is the smallest among the weight of the M*N ground grids and the weight of the above-ground grid.

20. The non-transitory computer storage medium of claim 14, wherein before determining the grid division pattern and the corresponding weight assignment manner according to the installation posture and the acquisition perspective of the vehicle-mounted camera, the operations further comprise:
preprocessing the image to obtain a region of interest (ROI) in the image, the preprocessing at least comprising removing an invalid region in the image; and
wherein dividing the image into the above-ground grid and the preset number of ground grids by using the grid division pattern comprises:
taking the ROI as a division object of the grid division pattern, and dividing the ROI using the grid division pattern to divide the ROI into the above-ground grid and the preset number of ground grids.
